(19) United States
(12) Patent Application Publication
(10) Pub. No.: US 2011/0017696 A1
(43) Pub. Date: Jan. 27, 2011

(54) Nursing Bottle Feeding Nipple

(75) Inventors: David Elad, Tel Aviv (IL); Ori Saretsky, Kdumim (IL)

Correspondence Address: The Law Office of Michael E. Kondoudis, 888 16th Street, N.W., Suite 800, Washington, DC, 20006, US

(73) Assignee: PHYSIONIP LTD., Haifa (IL)

(21) Appl. No.: 12/933,516

(22) PCT Filed: Mar. 19, 2009
(86) PCT No.: PCT/IB09/51166

§ 371 Date: Sep. 20, 2010

Related U.S. Application Data
(60) Provisional application No. 61/064,684, filed on Mar. 20, 2008.

(51) Int. Cl. A61J 9/00

(52) U.S. Cl. 215/11.1

(57) ABSTRACT

A nursing bottle feeding nipple is provided, which comprises a flexible outer shell formed in a shape mimicking that of the feminine breast and extending between a nipple end and a bottle coupling end. The feeding nipple is sealingly fitted at the bottle coupling end with a sealing disc defining therebetween a confined sealed space. The feeding nipple includes a plurality of feeding ducts extend between inlet ports formed at the sealing disc and outlet ports formed at the nipple end. The feeding ducts mimic the feminine anatomical lactiferous ducts.

### FIELD OF THE INVENTION

The present invention relates to baby bottle feeding nipples (also referred to as nursing/suckling nipples). More particularly the present invention is concerned with baby bottle feeding nipples which mimic the physiological mechanism of breast feeding.

### BACKGROUND OF THE INVENTION

There is an ongoing attempt to improve the design of bottle feeding nipples so as to closely mimic the attributes of the human breast nipple, both as far as shape anatomy/ergonomics (i.e. shape and sensation of the nipple) and as far as parameters concerned with liquid flow therethrough.

Breastfeeding during infancy has been found to supply an optimal source of nutrients for growth and development. Human milk is created in many clusters of up to 100,000 alveoli within the breast and delivered via the branching network of the lactiferous (or mammary) ducts to 15-20 lactiferous sinuses (or ampullae) which are located directly underneath the areola and ultimately extend into the nipple (FIG. 1). The lactiferous sinuses converge into 5-10 ducts in the nipple that allow the milk to be expelled through the 5 to 10 openings in the nipple tip. The averaged diameter of the ducts is in the range of 0.5 to 1.2 mm. The nipple is made up of smooth muscles and the milk conducting ducts.

The baby sucks milk from the breast in a dynamic process, which requires coupling between rhythmic pulsation of the surface of the tongue and the mother's milk ejection reflex. During correct suckling, the baby latches on to the breast and the nipple in a way that the areola and the underlying mammary sinuses are drawn into the infant's mouth and under its gums and a long ‘teat’ is formed (FIG. 2A).

Milk is removed from the lactiferous sinuses not so much by suction as by compressing the areola (and the underlined sinuses) with the infant's gums and the stripping motion of the tongue against the hard palate. This cyclic motion at rates of about IHz carries milk through the teat and into the infant's mouth (FIG. 2). The sinuses refill as the continued action of oxytocin (i.e. let-down reflex) forces milk from the alveoli into the ducts (FIGS. 2B to 2F).

Several Patents are concerned with baby feeding nipples mimicking breastfeeding. For example WO2007137440 discloses a teat for feeding bottles consisting of a receiving head produced from a dimensionally stable material, and a rubber-elastic suction element, produced from a rubber-elastic material. An entry channel leading to the interior of the bottle and channels leading from there to the outer surface of the receiving head are configured in the receiving head. The suction element, in an initial position, elastically and sealingly rests on at least one section of an outer surface of the receiving head. Milk ducts are located in the contact area between the suction element and the receiving head and communicate on the one end with the channels of the receiving head which lead towards the outlet channel in the mouthpiece so that, when a vacuum is produced in the mouthpiece, milk can flow from the feeding bottle through the milk ducts to the outlet channel, the suction element being returnable to its initial position and the flow of milk being interrupted when there is no vacuum.

U.S. Pat. No. 6,818,162 discloses methods for fabricating baby bottle nipples comprising at least one hydrophilic fluid delivery passage. In one embodiment, the fluid delivery passage is a microtube. In another embodiment, the fluid delivery passage is a microchannel. In yet another embodiment, the fluid delivery passage comprises a porous reticulated foam with interconnected pores. In each of these embodiments, the fluid delivery passage has at least one dimension in the range of 1-2000 microns, wherein baby-feeding is based on capillary action fluid-delivery capillaries ducts.

U.S. Pat. No. 6,588,613 discloses a baby bottle nipple having the common feature of at least one hydrophilic fluid delivery passage. In one embodiment, the fluid delivery passage is a microtube. In another embodiment, the fluid delivery passage is a microchannel. In yet another embodiment, the fluid delivery passage comprises aporous reticulated foam with interconnected pores. In each of these embodiments, the fluid delivery passage has at least one dimension in the range of 1-2000 microns, wherein baby-feeding is based on capillary action fluid-delivery capillaries ducts.

### SUMMARY OF THE INVENTION

It is an object of the present invention to provide a baby bottle feeding nipple which mimics breast feeding both as far as shape anatomy/ergonomics (i.e. shape and sensation of the nipple) and as far as parameters concerned with liquid flow therethrough, i.e. physiological mechanism associated with milk extraction from the breast during breast feeding.

The present invention is concerned with an artificial nipple for milk uptake by using the same suckling mechanism as in breastfeeding, i.e. cyclic compression of the lactiferous sinuses a by the infant's frontal gums. Accordingly, the feeding nipple mimics the physiology functional architecture of the breast nipple anatomy by having special milk conducting tubes embedded within an incompressible structure whose geometry is similar to that of the breast areola and nipple.

According to the present invention there is provided a nursing bottle feeding nipple comprising a flexible outer shell formed in a shape mimicking that of the feminine breast and extending between a nipple end and a bottle coupling end, said feeding nipple is sealingly fitted at the bottle coupling end with a sealing disc defining therebetween a confined sealed space; a plurality of feeding ducts extend between inlet ports formed at the sealing disc and outlet ports formed at the nipple end; said feeding ducts mimicking the feminine anatomical lactiferous ducts.

According to an other aspect of the present invention there is provided a nursing bottle fitted with a feeding nipple comprising a flexible outer shell formed in a shape mimicking that of the feminine breast and extending between a nipple end and a bottle coupling end, said feeding nipple is sealingly fitted at the bottle coupling end with a sealing disc defining therebetween a confined sealed space; a plurality of feeding ducts extend between inlet ports formed at the sealing disc and outlet ports formed at the nipple end; said feeding ducts mimicking the feminine anatomical lactiferous ducts.

Any one or more of the following features and designs may be applied to the feeding nipple subject of the present invention:
The bottle coupling end of the feeding nipple is fitted with a laterally extending rim for coupling to a nursing bottle;
The feeding nipple and/or a coupling ring for coupling to a nursing bottle are fitted with an air intake arrangement, e.g. in the form of intake apertures, to facilitate air ingress into the nursing bottle during suckling;
The confined sealed space is filled with a substance imparting the feeding nipple the sensation of a female breast. Said substance may be a liquid, a viscous material, etc.;
The softness of the feeding nipple may vary to suit different desired sensations. The softness may be a parameter defined by the geometry and thickness of the outer shell of the feeding nipple, or by the viscosity, density and pressure of the substance filling the confined space, or by a combination of both;
According to one particular embodiment, the outlet ports of the feeding ducts are cylindrical;
According to an particular design, a portion of the feeding ducts extending under an areola mimicking area of the feeding nipple is expanded, thereby simulating the mammary sinuses of a female breast;
A lower portion of the feeding ducts extending from the inlet ports may have a conically diverging geometry;
The feeding nipple may assume different shapes and sizes to conform a variety of babies' mouth anatomy.

### BRIEF DESCRIPTION OF THE DRAWINGS

In order to understand the invention and to see how it may be carried out in practice, an embodiment will now be described, by way of a non-limiting example only, with reference to the accompanying drawings, in which:

FIG. 1 is a schematic illustration of the anatomy of a female's breast;

FIGS. 2A to 2F are is schematic illustrations of consecutive sucking steps during suckling;

FIG. 3A is a top isometric view of a baby feeding nipple according to the present invention;

FIG. 3B is a sectioned view of the feeding nipple of FIG. 3 A;

FIG. 3C is a top view of the feeding nipple of FIG. 3 A; and

FIG. 4 is longitudinally sectioned side view of a nursing bottle fitted with a feeding nipple according to the present invention.

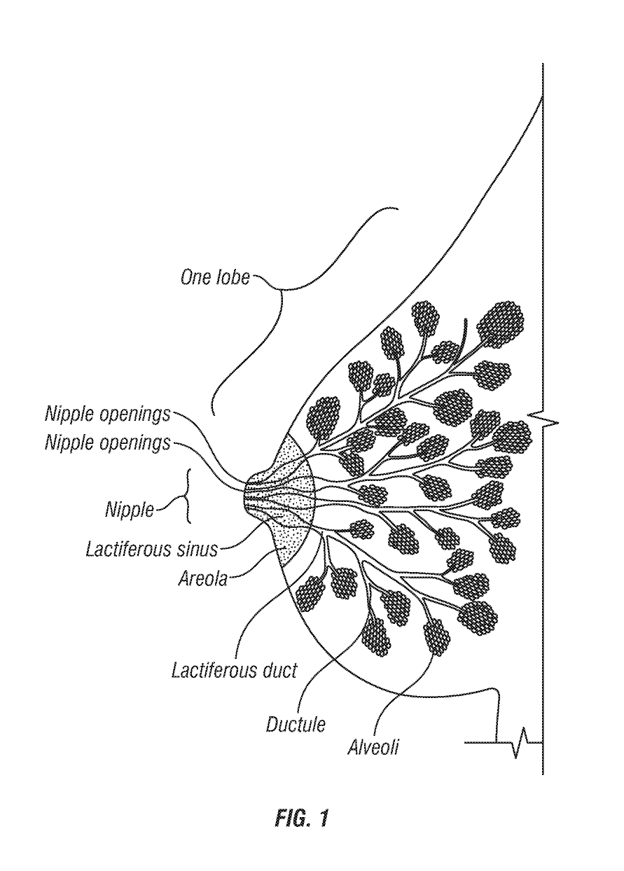

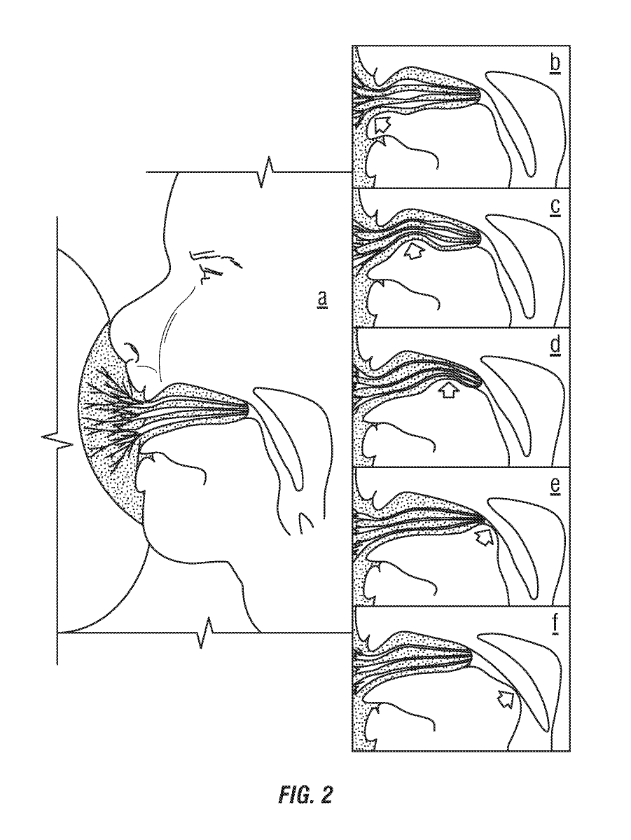

### DETAILED DESCRIPTION OF EMBODIMENTS

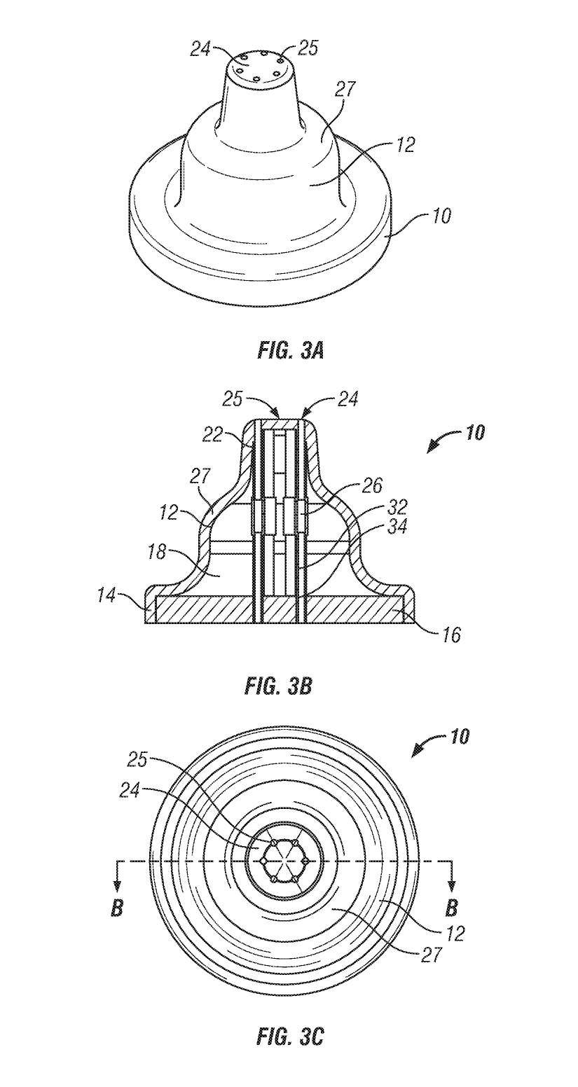

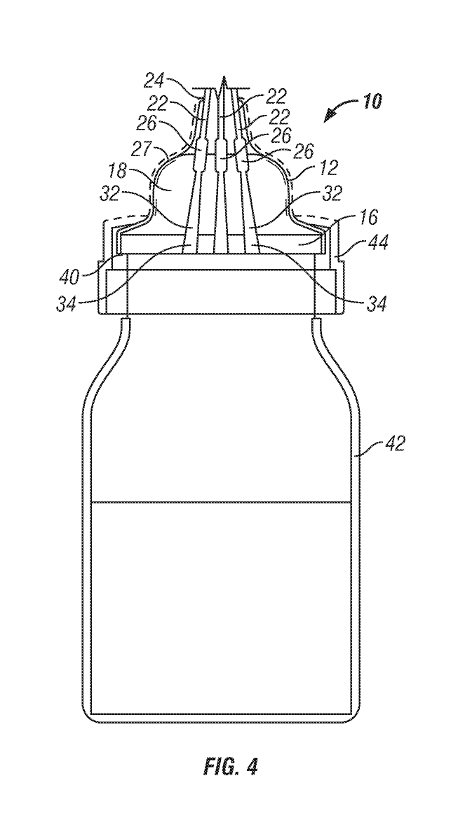

Attention is first directed to FIGS. 3A to 3C and 4 illustrating a feeding nipple according to the present invention, generally designated 10. The feeding nipple 10 has an outer shell 12 in the shape of the idealized anatomical geometry of the nipple and areola regions of the feminine breast. The feeding nipple 10 may be manufactured in different shapes and sizes.

A base of the feeding nipple is formed with a radial rim 14 laterally projecting, suited for securing to an opening 40 of a nursing bottle 42, by a screw coupling ring 44.

The shape and size of the rim 14 are designed for engagement with commercially available nursing bottles, though feeding nipples of the present invention may be formed with specially designed rims.

The feeding nipple 10 is fitted at its base end with a sealing disc 16 sealingly secured to the shell 12, thus forming a sealed space 18. The material of which the shell 12 is made of and its form (e.g. thickness and density) together with a substance occupying the space 18 define the softness/tenderness of the feeding nipple 10 so as to mimic the softness of the mother's breast. According to variations of the invention, the space 18 is filled with an incompressible liquid (e.g., saline or silicon). The softness of the nipple can also be controlled by the viscosity of the inner liquid. The sealing disc 16 is secured to the outer shell 12 in a leak-proof manner, e.g. by adhering or by sealingly welding to the shell, etc.

The feeding nipple 10 is formed with a plurality of feeding ducts 22 extending from the nipple end 24 of the shell 10 towards the sealing disc 16, said feeding ducts 22 mimicking the anatomical lactiferous ducts and sinuses, with a fluid flow path extending between inlet ports 34 towards outlet ports 25, The feeding ducts 22 are typically formed integrally within shell 12 and are thus made of the same material, imparting them flexibility.

The feeding nipple is made of materials used in the art of manufacturing baby pacifiers and nursing bottle nipples, such as natural latex, liquid silicon rubber etc.

According to one particular design of the feeding nipple of the present invention, the thickness of the shell 12 is about 1 mm and the averaged nipple diameter is 15 mm with a length of about 15 mm.

The feeding ducts 22, according to a specific design have an inner diameter of about 1 mm at the outlet ports 34 and have an averaged wall thickness of about 0.2 mm.

In the disclosed embodiment outlet ports 25 of the feeding ducts 22 are cylindrical at the nipple end 24 (FIG. 3A) and have an expanded section 26 under the areola mimicking area 27 simulating the mammary sinuses (Lactiferous sinuses). A lower portion 32 of the feeding ducts 22 may be either cylindrical or have a conically diverging geometry (FIGS. 3B and 4), terminating at distal inlet ports 34. However it is appreciated that the cross section of the feeding ducts may be other than circular and further, that the cross section may vary along the length of the ducts and that the diverging geometry may extend along the entire length of the ducts or along a portion thereof, or may be omitted. Evenmoreso, the geometry of ducts of a feeding nipple may differ from one another. Typically, the feeding ducts 22 are symmetrically distributed within the feeding nipple 10 and likewise the outlet ports 25 are symmetrically distributed over the nipple end 24 and the inlet ports 34 are symmetrically distributed over the sealing disc 16.

The number of feeding ducts 22 and/or their diameter is defined by the required flow rate of milk delivery at each cycle of the infant's gums compression of the nipple. The dynamics of liquid suckling with the feeding nipple 10 according to the present invention when fitted on a nursing bottle 42 (FIG. 4) is very similar to, and in fact mimics that of breastfeeding from mum's nipple. It does not require suction of the liquid with a sealed off mouth, but rather cyclic movement of the jaws that press the gums against the areola portion 27 of the feeding nipple 10. The suckling dynamics is facilitated owing to flexibility of the feeding nipple 10 (including the shell 12, the feeding ducts 22 and the substance occupying the space 18) and the geometry of the feeding ducts formed with the expanded section 26.

A feeding nipple 10 according to the present invention offers, among others, the following advantages: The feeding nipple according to the present invention allows the baby to remove milk into his mouth by cyclic movements of his jaws against the areola region of the nipple.

The breastfeeding-like feature of the feeding nipple according to the present invention enables milk suckling by the baby without complete sealing of the lips around the nipple in order to generate the suction pressure gradient. This is beneficial in reducing the amount of air swallowed by the baby with all its negative consequences, as known per-se.

As in breastfeeding, the baby can remove milk from the feeding nipple according to the present invention without blocking airflow between his lungs and the environment.

The breastfeeding-like mechanism of the feeding nipple according to the present invention may have an effect of expanding the period of breastfeeding e.g. for mothers that need to return to work.

Furthermore, the feeding nipple according to the present invention may be utilized so as to avoid milk confusion.

The feeding nipple according to the present, invention may be designed to fit any commercially available nursing bottle.

The feeding nipple according to the present invention may serve as a major component of a breastfeeding simulator, which will objectively expand the scientific knowledge in the important field of breastfeeding.

The feeding nipple according to the present invention may help training newborns for breastfeeding.

The feeding nipple according to the present invention can be manufactured in different sizes and softness to fit a variety of baby's mouth anatomy.

The feeding nipple and/or a coupling ring for coupling to a nursing bottle are fitted with an air intake arrangement. Such an arrangement may be in the form of intake apertures fitted on the rim 14 (not seen) or at the coupling ring 44 (not seen), to thereby facilitate air ingress into the nursing bottle during suckling.

Those skilled in the art to which this invention pertains will readily appreciate that numerous changes, variations, and modifications can be made without departing from the scope of the invention, mutatis mutandis.

1. A nursing bottle feeding nipple, comprising:
a flexible outer shell characterized by having a shape mimicking that of the feminine breast, said outer shell of said feeding nipple is sealingly fitted at the bottle coupling end with a sealing disc defining therebetween a confined sealed space;
a plurality of feeding ducts extending between inlet ports formed at said sealing disc and outlet ports formed at the nipple end; wherein at least a portion of at least one of said feeding ducts is characterized by a cross section which vary along the length of said portion such that said at least one feeding duct mimics the feminine anatomical lactiferous ducts.

2. The nursing bottle feeding nipple according to claim 1, wherein said bottle coupling end of said feeding nipple is fitted with a laterally extending rim for coupling to a nursing bottle.

3. The nursing bottle feeding nipple according to claim 1, wherein the confined sealed space is filled with a substance imparting said feeding nipple the sensation of a female breast.

4. The nursing bottle feeding nipple according to claim 1, wherein the softness of the feeding nipple may vary to suit different desired sensations; further wherein said softness is defined by at least one parameter selected from a group consisting of the geometry of said outer shell of said feeding nipple, the thickness of said outer shell of said feeding nipple or any combination thereof.

5. (canceled)

6. The nursing bottle feeding nipple according to claim 1, wherein the outlet ports of at least one of said feeding ducts are substantially circular; further wherein a lower portion of at least one of said feeding ducts extending from the inlet ports have a conically diverging geometry.

7. The nursing bottle feeding nipple according to claim 1, wherein a portion of said feeding ducts extending under an areola mimicking area of said feeding nipple is expanded, so as to simulate the mammary sinuses/lactiferous sinuses of a female breast.

8. (canceled)

9. (canceled)

10. The nursing bottle feeding nipple according to claim 2, wherein said rim is fitted with an air intake arrangement in the form of intake apertures facilitating air ingress into said nursing bottle during suckling.

11. A nursing bottle fitted with feeding nipple, comprising
a flexible outer shell characterized by having a shape mimicking that of the feminine breast, said outer shell of said feeding nipple is sealingly fitted at the bottle coupling end with a sealing disc defining therebetween a confined sealed space;
a plurality of feeding ducts extending between inlet ports formed at said sealing disc and outlet ports formed at the nipple end; wherein at least a portion of at least one of said feeding ducts is characterized by a cross section which vary along the length of said portion such that said at least one feeding duct mimics the feminine anatomical lactiferous ducts.

12. The nursing bottle according to claim 11, wherein said confined sealed space is filled with a substance imparting said feeding nipple the sensation of a female breast.

13. The nursing bottle according to claim 11, wherein the softness of the feeding nipple may vary to suit different desired sensations; further wherein said softness is defined by at least one parameter selected from a group consisting of the geometry of said outer shell of said feeding nipple, the thickness of said outer shell of said feeding nipple or any combination thereof.

14. (canceled)

15. The nursing bottle according to claim 11, wherein a portion of said feeding ducts extending under an areola mimicking area of said feeding nipple is expanded, so as to simulate the mammary sinuses/lactiferous sinuses of a female breast; further wherein a lower portion of at least one of said feeding ducts extending from the inlet ports have a conically diverging geometry.

16. (canceled)

17. (canceled)

18. The nursing bottle feeding nipple according to claim 1, wherein said at least one of said feeding ducts is characterized by a shape selected from a group consisting of cylindrical shape, conical, circular shape or any combination thereof.

19. The nursing bottle feeding nipple according to claim 3, wherein said substance is selected from a group consisting of a liquid, a viscous material incompressible liquid selected from a group consisting of saline or silicon or any combination thereof, or any combination thereof.

20. The nursing bottle feeding nipple according to claim 3, wherein the softness of the feeding nipple may vary to suit different desired sensations; further wherein said softness is defined by at least one parameter selected from a group consisting of the viscosity of said substance, density, of said substance, pressure of said substance filling said confined space, or a combination thereof.

20. The nursing bottle feeding nipple according to claim 1, wherein said feeding nipple is made of materials selected from natural latex, liquid silicon rubber or any combination thereof.

21. The nursing bottle feeding nipple according to claim 1, wherein the thickness of said outer shell ranges from about 0.1 mm to about 1 mm and the averaged nipple diameter ranges from about 0.5 mm to about 15 mm with a length of about 15 mm; further wherein said outer shell is adapted to assume different shapes and sizes to conform a variety of babies' mouth anatomy.

22. The nursing bottle feeding nipple according to claim 1, wherein said nursing bottle feeding nipple is utilized to help training newborns for breastfeeding.

23. The nursing bottle according to claim 11, wherein said at least one of said feeding ducts is characterized by a shape selected from a group consisting of cylindrical shape, conical, circular shape or any combination thereof.

24. The nursing bottle according to claim 12, wherein said substance is selected from a group consisting of a liquid, a viscous material, incompressible liquid selected from a group consisting of saline or silicon or any combination thereof, or any combination thereof.

25. The nursing bottle according to claim 12, wherein the softness of the feeding nipple may vary to suit different desired sensations; further wherein said softness is defined by at least one parameter selected from a group consisting of the viscosity of said substance, density, of said substance, pressure of said substance filling said confined space, or a combination thereof.
